(19) United States
(12) Patent Application Publication
(10) Pub. No.: US 2023/0283159 A1
(43) Pub. Date: Sep. 7, 2023

(54) Magnetic Gearshift System

(71) Applicants: Politecnico di Torino, Torino (IT); UNIVERSITÀ DEGLI STUDI DI PADOVA, Padova (IT)

(72) Inventors: Elvio Bonisoli, Torino (IT); Luca Dimauro, Torino (IT); Alessandro Vigiani, Torino (IT); Mauro Velardocchia, Torino (IT); Maurizio Repetto, Torino (IT); Vincenzo Cirimele, Torino (IT); Piergiorgio Alotto, Padova (IT); Mattia Filippini, Padova (IT)

(21) Appl. No.: 18/005,820

(22) PCT Filed: Jul. 14, 2021
(86) PCT No.: PCT/IB2021/056344

§ 371 Date: Jan. 17, 2023

(30) Foreign Application Priority Data
Jul. 17, 2020 (IT) 102020000017512

(51) Int. Cl. H02K 49/10

(52) U.S. Cl. CPC H02K 49/102

(57) ABSTRACT

The present invention relates to a magnetic gearshift system including a first permanent-magnet multipolar magnetic rotor, a second permanent-magnet multipolar magnetic rotor and a first magnetic or ferromagnetic modulator. According to one aspect of the present invention, the first modulator is configured for taking a first position, corresponding with the first permanent-magnet multipolar magnetic rotor, wherein the first modulator is adapted to modulate the transmission of the first permanent-magnet multipolar magnetic rotor, and a second position, corresponding with the second permanent-magnet multipolar magnetic rotor, wherein the first modulator is adapted to modulate the transmission of the second permanent-magnet multipolar magnetic rotor.

### BACKGROUND OF THE INVENTION

### 1. The Field of the Invention

The present invention relates to a magnetic gearshift system. In particular, the present invention falls within the field of motion transmission systems for transferring mechanical power, generated by a power source, to a power-using apparatus. In the present description, the term power-using apparatus will refer to any apparatus capable of absorbing and using mechanical power transmitted by a transmission system. A gearshift system is an apparatus, usually of the mechanical type, characterized by discrete transmission ratios, with at least two transmission ratios, which may be considered as either constant or variable, but which have a mean value other than zero, e.g., as in a chain transmission; it is used in order to change the transmission ratio between the output of the power source and the input of the power-using apparatus. According to techniques known in the art, gearshift systems are widely employed in many applications. For example, in the vehicle industry it is known to use gearshift systems for suitably varying the torque transferred from the engine to the vehicle wheels via a transmission system. Similarly, gearshift systems are notoriously used in many other technical fields, such as, for example, electric tools, surgical equipment, or energy transformers like, for example, wind turbines, etc. In general, as will become apparent in the course of the present description, the magnetic gearshift system of the present invention can advantageously be used for any application requiring that the transmission ratio can be suitably varied between the output of a mechanical power source and the input of a generic power-using apparatus.

### 2. The Relevant Technology

The gearshift systems known in the art are generally composed of a set of mechanical gears such as, for example, toothed wheels, pinions, racks, etc., so configured as to be able to assume a plurality of configurations depending on the desired transmission ratio. For example, a generic manual or robotic gearshift system for vehicular use consists of one or more primary shafts, whereon a number of toothed wheels are fitted corresponding to the number of transmission ratios, and one or two secondary shafts, whereon as many toothed wheels are fitted, which permit obtaining a given transmission ratio between input and output. The clutch is a component required for shifting gears, i.e., for changing the transmission ratio. In particular, it allows decoupling the engine from the primary shaft of the gearbox. In manual gearshift systems, the control lever is connected, via suitable linkages, to gearbox synchronizers, which are typically arranged on the secondary shafts or, more seldom, on the primary shaft. Such synchronizers permit engaging a gear by synchronizing the speed of idle gears on the secondary or primary shaft, thereby establishing a transmission ratio that permits controlling the speed of the secondary shaft. In double-clutch robotic gearshift systems, this task is carried out by suitable electrohydraulic or electromechanical actuators controlled by the gearbox control module. Therefore, during any gear change the following phases occur: clutch disengagement, synchronizer selection by the gearshift lever, gear synchronization, gradual clutch engagement, forward movement of the vehicle in the newly engaged gear.

In addition to construction and design complexity, mechanical gearshift systems also suffer from many other drawbacks. For example, the mechanical gearshift systems known in the art often include a clutch; this component, in addition to be very complex, is particularly subject to wear. Moreover, mechanical gearshift systems cannot, in their basic configuration, automatically provide a torque limiter function. According to known techniques, when the transferred torque needs to be limited it is necessary to add one or more torque limiters to the gearshift system; such additional components represent a disadvantage because, in addition to increasing the complexity of the system, they are notoriously subject to considerable wear. A further drawback of mechanical gearshift systems is the need for putting the gears of the system into direct contact with each other. In addition to causing gear wear, this feature requires periodic maintenance for lubricating the entire gearshift system, to ensure that it will work properly.

### SUMMARY OF THE INVENTION

In this frame, it is the main object of the present invention to provide a magnetic gearshift system which is so conceived as to overcome the drawbacks suffered by prior-art mechanical transmission systems.

In particular, it is one object of the present invention to provide a magnetic gearshift system which is so conceived as to limit or eliminate the contact areas between the gears included in the system.

It is a second object of the present invention to provide a magnetic gearshift system which can limit the torque transferred between the gears of the system without requiring any additional components.

It is a further object of the present invention to provide a magnetic gearshift system which can change the transmission ratio without requiring the use of any additional components subject to wear, like, for example, a clutch.

In order to solve the problems suffered by mechanical gearshift systems, the present invention comprises a plurality of magnetic gears. The use of magnetic gears is particularly advantageous, in that motion transmission occurs with no contact between the various parts of the gear. For example, patent US9013081 discloses a magnetic gear that uses an auxiliary motor for moving an intermediate rotor in order to vary the transmission ratio. Also, patent US8593026 describes a magnetic gear that uses auxiliary windings on the ferromagnetic poles of the internal rotor in order to adjust their saturation and their effect on the transmission ratio.

### BRIEF DESCRIPTION OF THE DRAWINGS

Further objects, features and advantages of the present invention will become apparent in light of the following detailed description and the annexed drawings, which are provided herein merely by way of non-limiting example, wherein:

FIG. 1 schematically shows the cross-section of a first type of permanent-magnet multipolar magnetic rotor and an associated modulator;

FIG. 2 schematically shows a three-dimensional image of a first type of permanent-magnet multipolar magnetic rotor and an associated modulator;

FIG. 3 schematically shows the cross-section of a second type of permanent-magnet multipolar magnetic rotor and an associated modulator;

FIG. 4 schematically shows a three-dimensional image of a second type of permanent-magnet multipolar magnetic rotor and an associated modulator;

FIG. 5 schematically shows the cross-section of a third type of permanent-magnet multipolar magnetic rotor and an associated modulator;

FIG. 6 schematically shows a three-dimensional image of a third type of permanent-magnet multipolar magnetic rotor and an associated modulator;

FIG. 7 schematically shows the cross-section of a fourth type of permanent-magnet multipolar magnetic rotor and an associated modulator;

FIG. 8 schematically shows a three-dimensional image of a fourth type of permanent-magnet multipolar magnetic rotor and an associated modulator;

FIGS. 9, 10 and 11 schematically show a magnetic gearshift system according to a first embodiment;

FIG. 12 schematically shows a magnetic gearshift system according to a second embodiment;

FIG. 13 schematically shows a magnetic gearshift system according to a third embodiment;

FIG. 14 schematically shows a magnetic gearshift system according to a fourth embodiment.

### DETAILED DESCRIPTION OF THE PREFERRED EMBODIMENTS

In the course of the present description, the term “permanent-magnet multipolar magnetic rotor” will refer to a magneto-mechanical system configured to be combined with a modulator; in particular, the combination between a permanent-magnet multipolar magnetic rotor and a modulator is such as to allow for motion transmission between one or more parts of the permanent-magnet multipolar magnetic rotor and the modulator. Therefore, in the course of the present description the term “modulator” will refer to a generic device configured to be combined with a permanent-magnet multipolar magnetic rotor and capable of modulating the transmission of motion between one or more parts of the permanent-magnet multipolar magnetic rotor and the modulator itself. In the course of the present description, the verb “to modulate” will refer to the action performed by a modulator in combination with a permanent-magnet multipolar magnetic rotor, in order to effect the transmission of motion between the different parts of the permanent-magnet multipolar magnetic rotor and the modulator.

The magnetic gearshift system according to the present invention comprises at least a first permanent-magnet multipolar magnetic rotor and a second permanent-magnet multipolar magnetic rotor, each one characterized by predetermined transmission ratios. For the purpose of alternately activating the transmission of motion through the first permanent-magnet multipolar magnetic rotor or the second permanent-magnet multipolar magnetic rotor, the magnetic gearshift system of the present invention comprises also a modulator capable of alternately combining with the first or the second permanent-magnet multipolar magnetic rotor. In particular, such modulator is configured for taking at least a first position in combination with said first permanent-magnet multipolar magnetic rotor and at least a second position in combination with said second permanent-magnet multipolar magnetic rotor. According to one aspect of the present invention, the first position is such that the modulator corresponds with the first permanent-magnet multipolar magnetic rotor, so as to modulate the transmission of the first permanent-magnet multipolar magnetic rotor. Likewise, the second position is such that the modulator corresponds with the second permanent-magnet multipolar magnetic rotor, so as to modulate the transmission of the second permanent-magnet multipolar magnetic rotor.

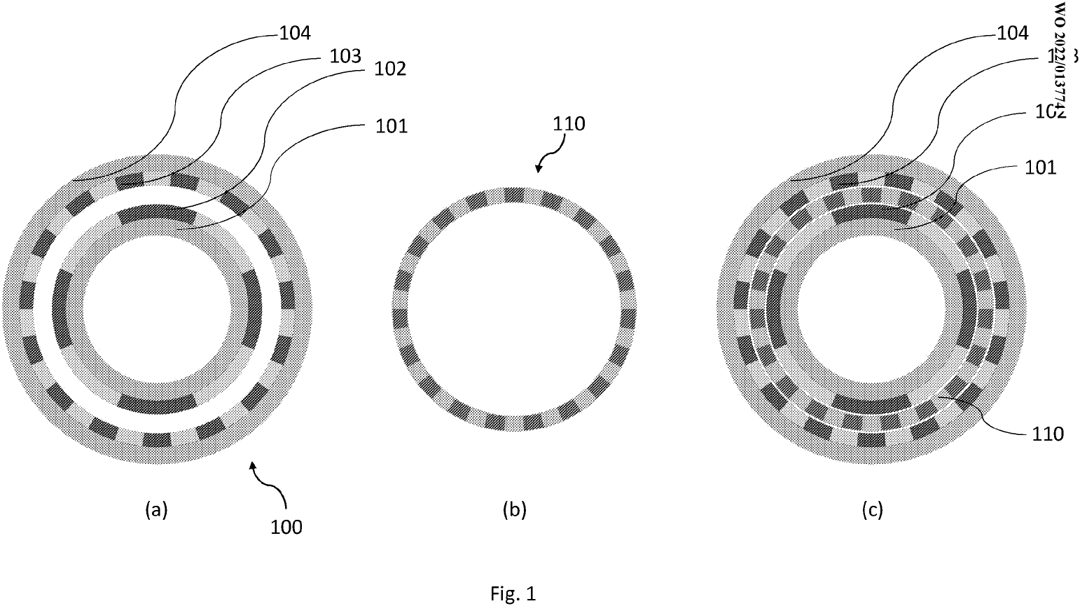

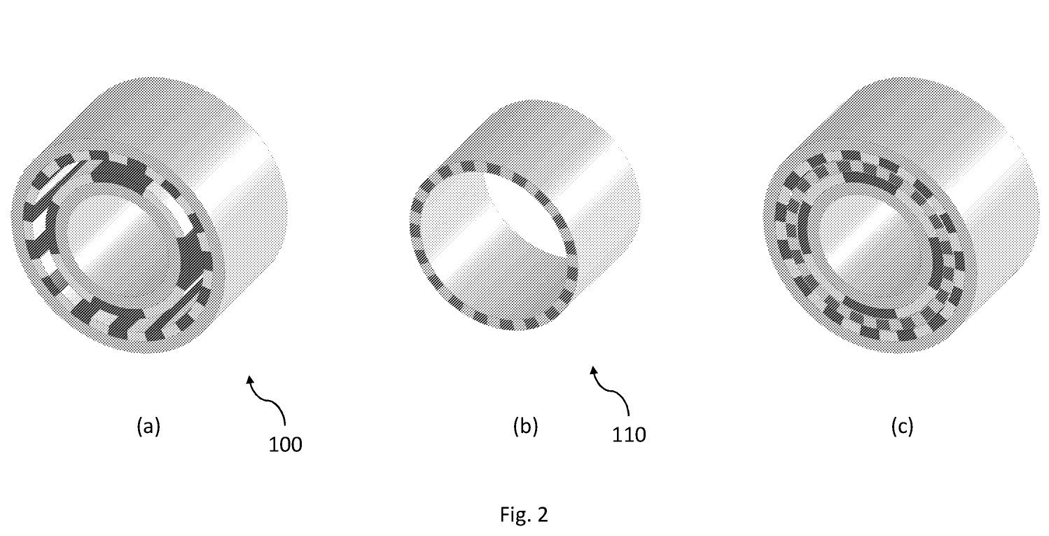

With reference to the annexed drawings, reference numeral 100 in FIGS. 1a and 2a designates as a whole an example of a first type of permanent-magnet multipolar magnetic rotor 100 used in a magnetic gearshift system according to the present invention; FIGS. 1b and 2b show, as a whole, a ferromagnetic modulator 110 used in a gearshift system according to the present invention, configured to be combined with the first multipolar magnetic rotor 100. In FIGS. 1c and 2c the multipolar magnetic rotor 100 is shown in combination with the modulator 110. In the example depicted in FIGS. 1a, 1b, 1c and 2a, 2b, 2c, the multipolar magnetic rotor 100 comprises at least an internal rotor and an external rotor configured for rotating about an axis of rotation. The internal rotor comprises a supporting member 101 (also referred to as “yoke” in the present description) and a plurality of permanent magnets 102 having different configurations and magnetization directions. Likewise, the external rotor comprises a supporting member 104 and a plurality of permanent magnets 103 having different configurations and magnetization directions. Also the modulator 110 comprises a rotor comprising a supporting structure, e.g., made of resin or another non-ferromagnetic material, and a plurality of ferromagnetic elements arranged angularly equidistant, and configured to be disposed coaxial to the internal and external rotors; in order to allow interaction among the magnetic fields of the internal and external rotors of the multipolar magnetic rotor 100, the modulator 110 is configured in a manner such that it can be interposed between the internal rotor and the external rotor as shown in FIGS. 1c and 2c. Through the interposition of the modulator 110, the multipolar magnetic rotor 100 becomes a magnetic gear, i.e., a system capable of transmitting torque.

By way of example, the internal rotor may comprise a plurality of magnetic elements 102 forming a number of polar pairs Pi, while the external rotor may comprise a plurality of magnetic elements 103 forming a number of polar pairs Po. The ferromagnetic modulator 110 may comprise a number of ferromagnetic elements forming a number of ferromagnetic poles q separated by a number q of air gaps.

When the internal and external rotors of the multipolar magnetic rotor 100 with periodicity Pi and Po are combined with the modulator 110, the action of the ferromagnetic poles q is such as to generate a coupling between the magnetic fields produced by the internal and external rotors with periodicity Pi and Po. Such coupling is such as to permit the transmission of motion between the rotors of the multipolar magnetic rotor 100, and possibly also the rotor of the modulator 110, if the latter is not held stationary; the maximum interaction between the magnetic fields generated by the rotors is obtained when the relationship q = Pi+Po is fulfilled. More specifically, when such relationship is fulfilled there is the maximum torque transfer between the two rotors. Furthermore, as is known, the transmission ratio between the internal and external rotors of the multipolar magnetic rotor 100 is directly dependent on the number of magnetic poles, Pi and Po, and of ferromagnetic poles q. According to techniques known in the art, it is possible to appropriately set the number of magnetic poles Po and Pi of the multipolar magnetic rotor 100 and the number of ferromagnetic poles q of the ferromagnetic modulator 110 to obtain a predetermined transmission ratio when the multipolar magnetic rotor 100 is combined with the modulator 110.

In general, in order to obtain a null or negligible transmission of motion between the internal and external rotors of the multipolar magnetic rotor 100, it is sufficient to decouple the multipolar magnetic rotor 100 from the modulator 110.

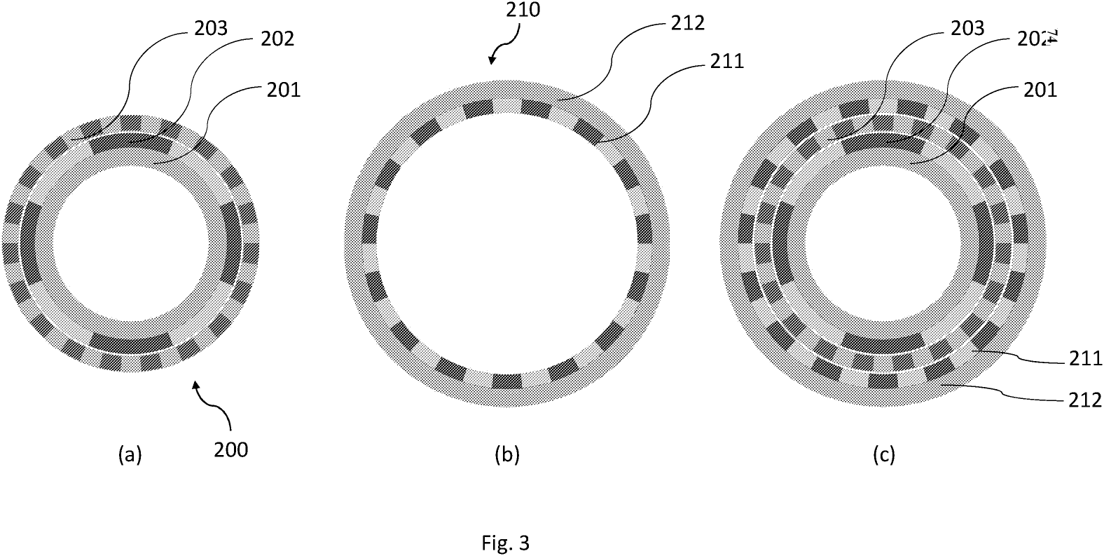

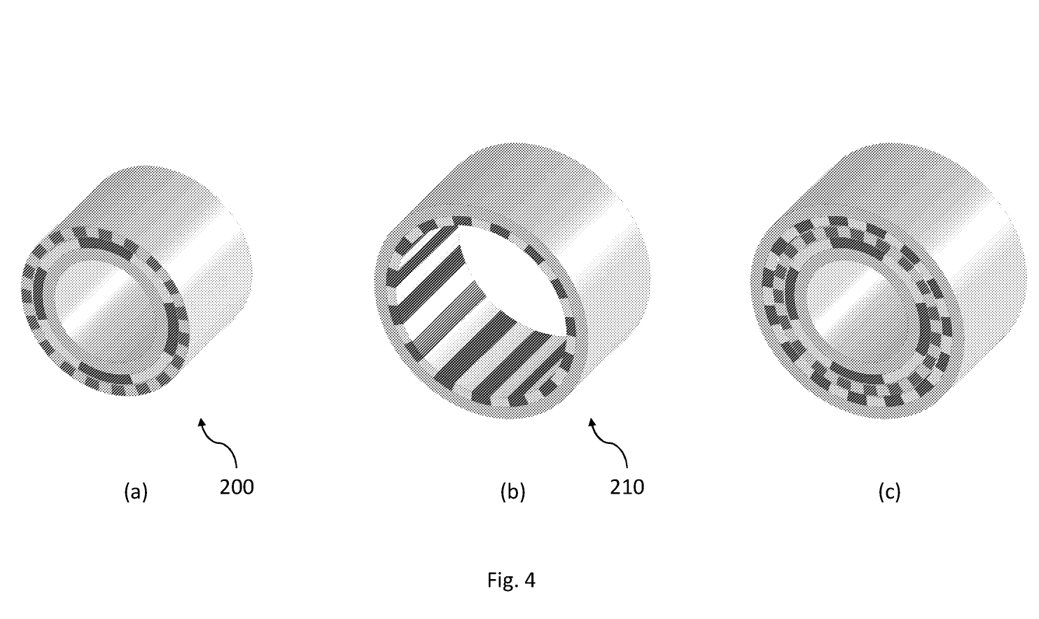

In FIGS. 3a and 4a, reference numeral 200 designates as a whole an example of a second type of permanent-magnet multipolar magnetic rotor 200 used in a magnetic gearshift system according to the present invention; FIGS. 3b and 4b show, as a whole, a magnetic modulator 210 used in a gearshift system according to the present invention, configured to be combined with the second type of multipolar magnetic rotor 200. In FIGS. 3c and 4c, the multipolar magnetic rotor 200 is shown in combination with the magnetic modulator 210. In the example depicted in FIGS. 3a, 3b, 3c and 4a, 4b, 4c, the multipolar magnetic rotor 200 comprises at least a magnetic internal rotor and a ferromagnetic intermediate rotor configured for rotating about an axis of rotation; optionally, the ferromagnetic intermediate rotor may be held stationary.

The internal rotor comprises a yoke 201 and a plurality of permanent magnets 202 having different configurations and magnetization directions. The intermediate rotor comprises a plurality of ferromagnetic elements 203. Also the modulator 210 comprises a rotor configured to be disposed coaxial to the internal and intermediate rotors of the multipolar magnetic rotor 200 and to rotate about an axis of rotation; the modulator 210 comprises a yoke 212 and a plurality of permanent magnets 211. In order to allow interaction between the magnetic fields of the internal rotor of the multipolar magnetic rotor 200 and of the magnetic modulator 210, the modulator 210 must be configured in such a way that it can be positioned externally to the multipolar magnetic rotor; in this way, the intermediate rotor turns out to be interposed between the magnetic internal rotor of the multipolar magnetic rotor 200 and the magnetic modulator 210, as shown in FIGS. 3c and 4c. Through the interposition of the modulator 210, the multipolar magnetic rotor 200 becomes a magnetic gear, i.e., a system capable of transmitting torque.

As described above with reference to the permanent-magnet multipolar magnetic rotor 100, the number of magnetic poles Pi and Po of the internal rotor and of the modulator 210 and the number of ferromagnetic poles q of the intermediate rotor can be appropriately set to obtain a predetermined transmission ratio when the multipolar magnetic rotor 200 is combined with the modulator 210. In general, in order to obtain a null or negligible transmission of motion between the parts of the multipolar magnetic rotor 200 and those of the modulator 210, it is sufficient to decouple the multipolar magnetic rotor 200 from the modulator 210.

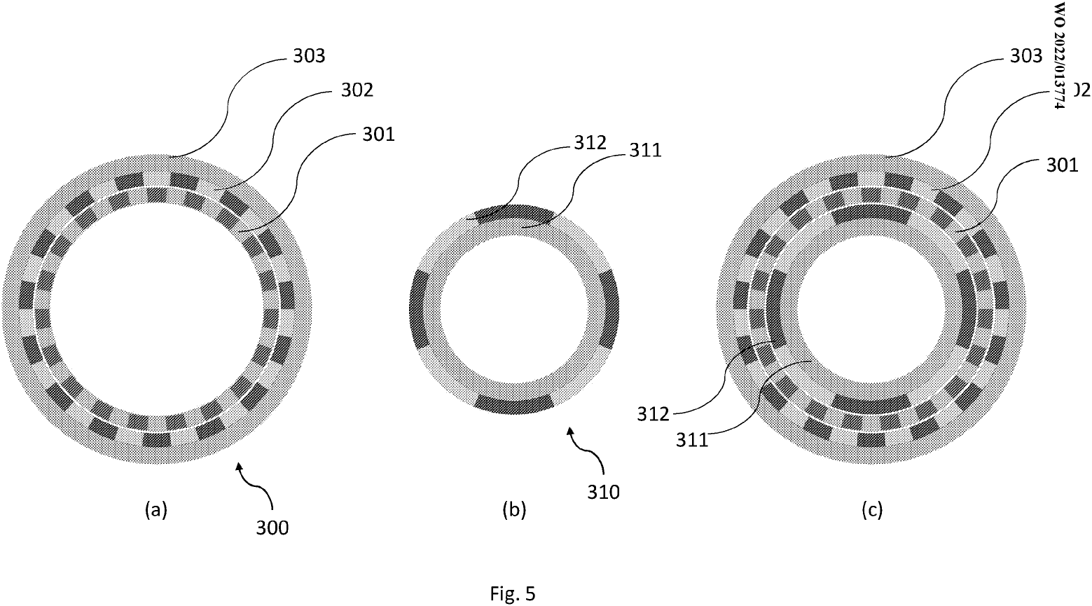

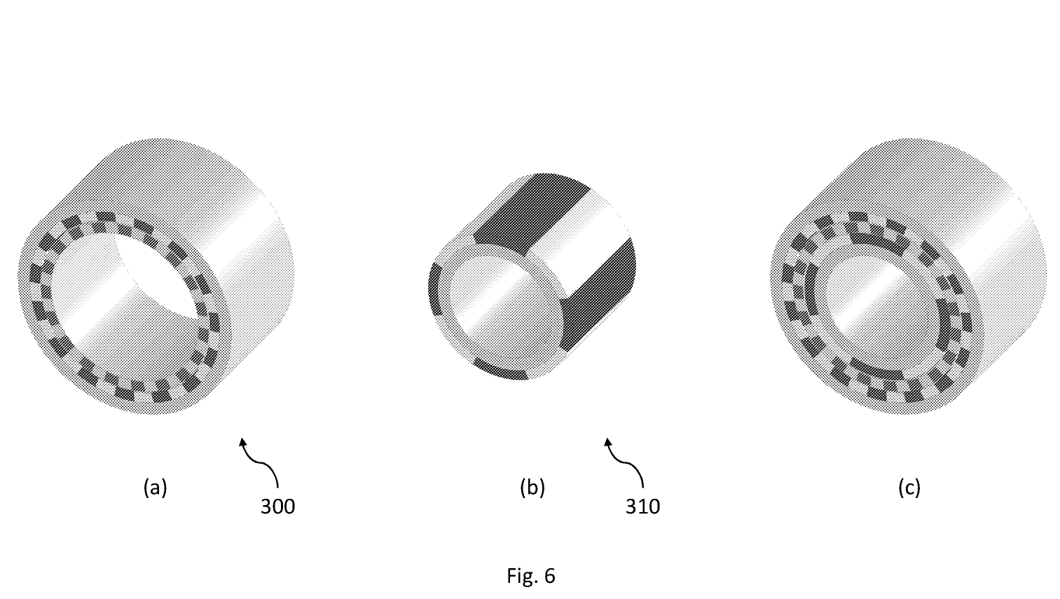

In FIGS. 5a and 6a, reference numeral 300 designates as a whole an example of a third type of permanent-magnet multipolar magnetic rotor 300 used in a magnetic gearshift system according to the present invention; FIGS. 5b and 6b show, as a whole, a magnetic modulator 310 used in a gearshift system according to the present invention, configured to be combined with the third type of multipolar magnetic rotor 300. In FIGS. 5c and 6c, the multipolar magnetic rotor 300 is shown in combination with the magnetic modulator 310. In the example depicted in FIGS. 5a, 5b, 5c and 6a, 6b, 6c, the multipolar magnetic rotor 300 comprises at least a magnetic external rotor and a ferromagnetic intermediate rotor configured for rotating about an axis of rotation; optionally, the ferromagnetic intermediate rotor may be held stationary.

The external rotor comprises a yoke 303 and a plurality of permanent magnets 302 having different configurations and magnetization directions. The intermediate rotor comprises a plurality of ferromagnetic elements 301. Also the modulator 310 comprises a rotor configured to be disposed coaxial to the external and intermediate rotors of the multipolar magnetic rotor 300 and to rotate about an axis of rotation; the modulator 310 comprises a yoke 311 and a plurality of permanent magnets 312. In order to allow interaction between the magnetic fields of the external rotor of the multipolar magnetic rotor 300 and the magnetic modulator 310, the modulator 310 must be configured in such a way that it can be positioned internally to the intermediate rotor; in this way, the intermediate rotor turns out to be interposed between the magnetic external rotor of the multipolar magnetic rotor 300 and the magnetic modulator 310, as shown in FIGS. 5c and 6c. Through the interposition of the modulator 310, the multipolar magnetic rotor 300 becomes a magnetic gear, i.e., a system capable of transmitting torque.

As described above with reference to the permanent-magnet multipolar magnetic rotor 100, the number of magnetic poles Pi and Po of the internal rotor and of the modulator 210 and the number of ferromagnetic poles q of the intermediate rotor can be appropriately set to obtain a predetermined transmission ratio when the multipolar magnetic rotor 200 is combined with the modulator 210. In general, in order to obtain a null or negligible transmission of motion between the parts of the multipolar magnetic rotor 300 and those of the modulator 310, it is sufficient to decouple the multipolar magnetic rotor 300 from the modulator 310.

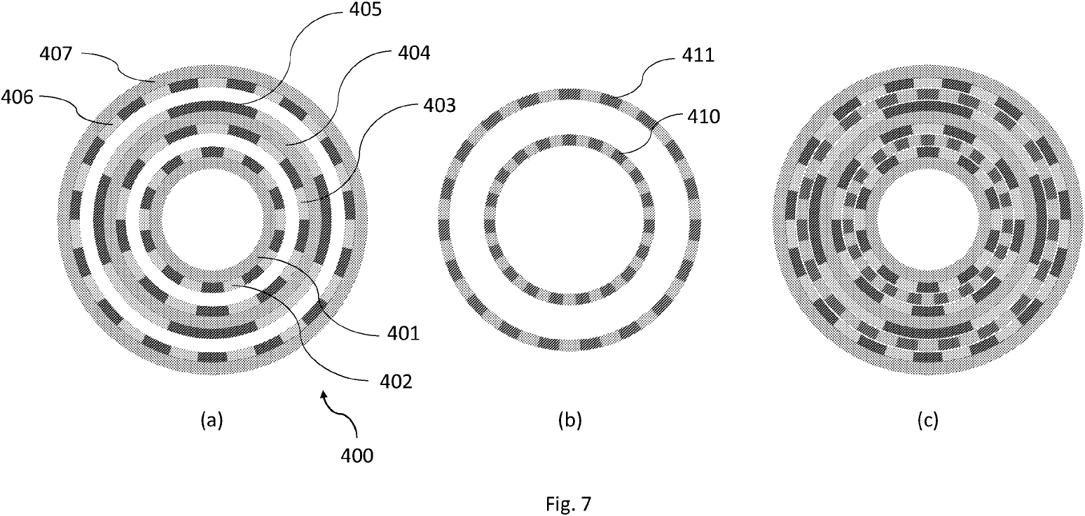

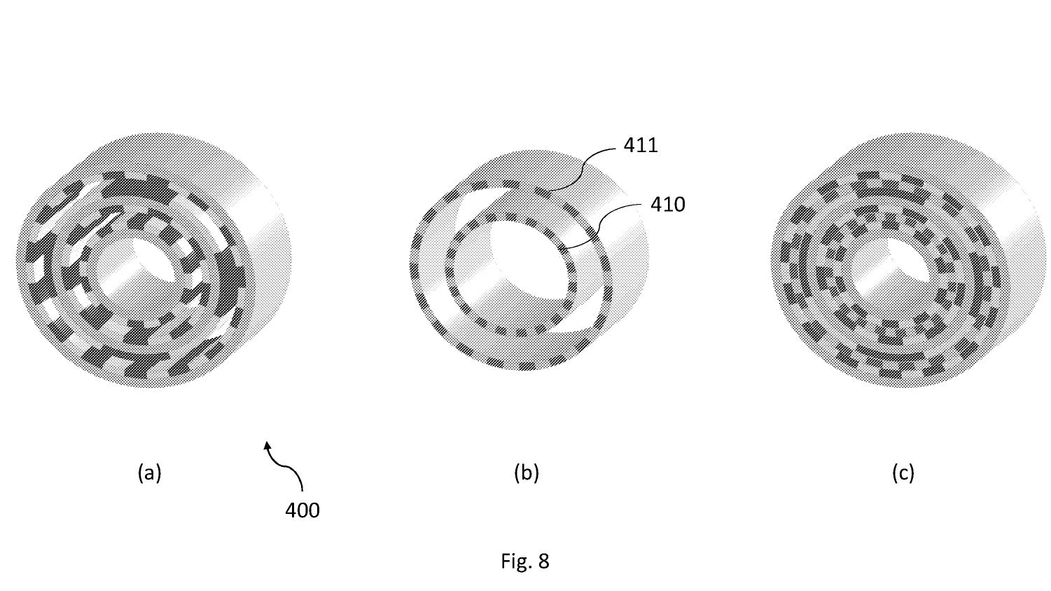

The first type of permanent-magnet multipolar magnetic rotor 100 may also be complemented with additional elements to form a fourth type of multipolar magnetic rotor. FIGS. 7a and 8a show a fourth type of permanent-magnet multipolar magnetic rotor 400 used in a magnetic gearshift system according to the present invention. The multipolar magnetic rotor 400 comprises an internal rotor and an external rotor of the magnetic type, which are structurally similar to the internal and external rotors of the multipolar magnetic rotor 100. The multipolar magnetic rotor 400 further comprises a magnetic intermediate rotor comprising a yoke 404, a first plurality of permanent magnets 403, arranged internally to the yoke 404, and a second plurality of permanent magnets 405, arranged externally to the yoke 404. The intermediate rotor is so arranged as to lie between the internal rotor and the external rotor. The internal, intermediate and external rotors are configured to rotate about an axis of rotation.

For the purpose of permitting the coupling between the electromagnetic fields generated by the plurality of permanent magnets 402 of the internal rotor and by the plurality of permanent magnets 403 of the intermediate rotor, the multipolar magnetic rotor 400 is configured to be combined with a first modulator 410, as shown in FIGS. 7c and 8c. Likewise, for the purpose of permitting the coupling between the electromagnetic fields generated by the plurality of permanent magnets 406 of the external rotor and by the plurality of permanent magnets 405 of the intermediate rotor, the multipolar magnetic rotor 400 is configured to be combined with a second modulator 411 as shown in FIGS. 7c and 8c. Through the interposition of the modulators 410 and 411, shown in FIGS. 7b and 8b, the multipolar magnetic rotor 400 becomes a magnetic gear, i.e., a system capable of transmitting torque. As described with reference to the modulator 110, the first modulator and the second modulator 410 and 411 must be of the ferromagnetic type and, conveniently, may be held stationary.

In general, in order to obtain a null or negligible transmission of motion between the rotors of the multipolar magnetic rotor 400 and those of the modulators 410 and 411, it is sufficient to decouple the multipolar magnetic rotor 400 from the first modulator 410 and/or the second modulator 411.

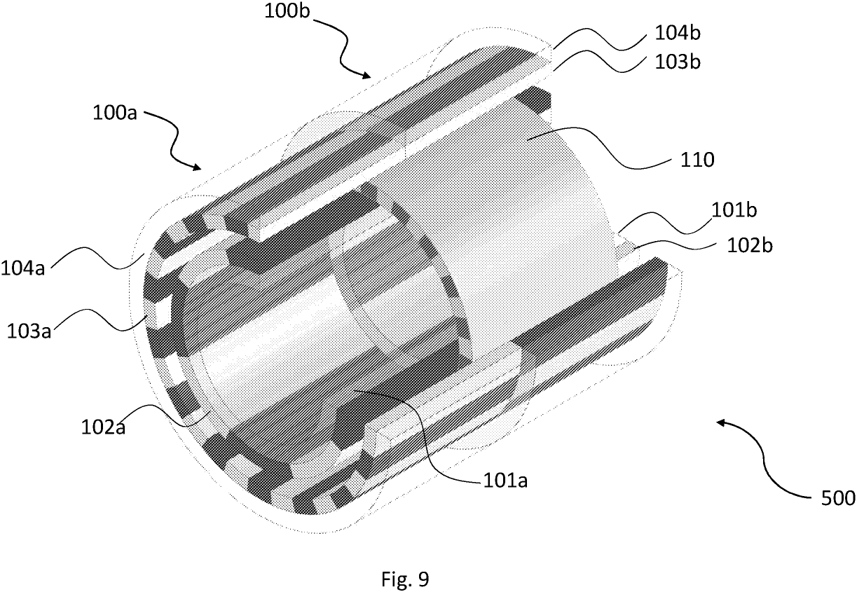

FIG. 9 shows a first embodiment of the magnetic gearshift system 500 according to the present invention, which provides two transmission ratios; the magnetic gearshift system 500 comprises two permanent-magnet multipolar magnetic rotors of the first type 100 (i.e., structurally similar or identical to the permanent-magnet multipolar magnetic rotor of the first type 100). In particular, reference numeral 100a designates a first permanent-magnet multipolar magnetic rotor comprising an internal first rotor and an external second rotor. Reference numeral 100b designates a second permanent-magnet multipolar magnetic rotor comprising an internal third rotor and an external fourth rotor. The internal and external rotors of the first and second permanent-magnet multipolar magnetic rotors, 100a and 100b, are arranged side by side and coaxial to each other. The gearshift system 500 further comprises a ferromagnetic modulator 110 coaxial to the permanent-magnet multipolar magnetic rotors 100a and 100b, and so configured that it can make an axial translational movement between the permanent-magnet multipolar magnetic rotors 100a and 100b. In particular, the modulator 110 is configured for taking at least a first position in combination with the first permanent-magnet multipolar magnetic rotor 100a and a second position in combination with the second permanent-magnet multipolar magnetic rotor 100b. When in the first position, the modulator 110 is so configured as to interpose itself between the internal first rotor and the external second rotor. The system resulting from the combination of the internal and external rotors with the modulator 110 is such as to permit the transmission of motion between the internal and external rotors and the modulator 110. In general, all the rotary parts of the gearshift system 500 (i.e., the internal rotors, the external rotors and the modulator 110) may be left free to rotate; alternatively, at least one of the rotary parts of the gearshift system 500 may be held stationary.

In the case wherein the modulator 110 is held stationary, the combination of the modulator 110 with the first permanent-magnet multipolar magnetic rotor 100a is such as to allow the transmission of motion only between the internal first rotor and the external second rotor. Likewise, when in the second position, the modulator 110 is so configured as to interpose itself between the internal third rotor and the external fourth rotor. The system resulting from the combination between the modulator 110 and the second permanent-magnet multipolar magnetic rotor 100b is such as to allow at least the transmission of motion between the internal third rotor and the external fourth rotor.

By way of example, the positioning of the modulator 110 can be effected by means of a linear slide allowing the modulator 110 to translate axially between the first position and the second position and preventing the modulator 110 from rotating (i.e., holding the modulator 110 stationary). Alternatively, the positioning of the modulator 110 can be effected by using sleeve-type or linkage-type solutions with similar kinematic characteristics.

In this manner, the transmission of the permanent-magnet multipolar magnetic rotors 100a and 100b can be modulated at will by suitably moving the modulator 110 from the first position to the second position, and vice versa. In other words, the transmission of motion between the rotors of the first permanent-magnet multipolar magnetic rotor 100a or between the rotors of the second permanent-magnet multipolar magnetic rotor 100b can be controlled, i.e., modulated, based on the position taken by the rotor 110. For example, when the rotor 110 is positioned in the first position, it is only possible to activate the transmission of motion between the internal first rotor and the external second rotor, while cancelling the interaction between the rotors of the second permanent-magnet multipolar magnetic rotor 100b. Likewise, when the modulator 110 is positioned in the second position, it is only possible to activate the transmission of motion between the internal third rotor and the external fourth rotor, while cancelling the interaction between the rotors of the first permanent-magnet multipolar magnetic rotor 100a.

The internal first and third rotors may move integrally with each other, and the same applies to the external second and fourth rotors. Since the modulator 110 is common to both permanent-magnet multipolar magnetic rotors 100a and 100b comprised in the gearshift system 500, the number of ferromagnetic elements q of the modulator 110 remains constant regardless of the position taken by the modulator 110. Conversely, the number of magnets comprised in the rotors of the permanent-magnet multipolar magnetic rotors 100a and 100b may be suitably set to establish distinct transmission ratios depending on the position taken by the modulator 110. For example, the number of permanent magnets comprised in the rotors of the first permanent-magnet multipolar magnetic rotor 100a may be suitably configured for establishing a first predefined transmission ratio. Likewise, the number of permanent magnets comprised in the rotors of the second permanent-magnet multipolar magnetic rotor 100b may be suitably configured for establishing a second predefined transmission ratio. For example, the number of permanent magnets of the rotors of the permanent-magnet multipolar magnetic rotor 100a may be such as to form, respectively, a number of polar pairs Pi and Po; likewise, the number of permanent magnets of the rotors of the permanent-magnet multipolar magnetic rotor 100b may be such as to form a number of polar pairs Pi′ and Po′, different from Pi and Po. In this manner, while still ensuring conditions of maximum interaction between the magnetic rotors (i.e., ensuring that the system of equations Pi+Po=q and Pi′+Po′=q is fulfilled), it is possible to obtain predefined and distinct transmission ratios for each permanent-magnet multipolar magnetic rotor 100a and 100b. The translational movement of the modulator 110 may thus be appropriately controlled to combine it with each one of the permanent-magnet multipolar magnetic rotors 100a and 100b in such a way as to establish distinct transmission ratios depending on the permanent-magnet multipolar magnetic rotor whereon the modulator 110 is positioned. Thus, depending on the position of the rotor 110, the gearshift system 500 can establish a number of transmission ratios at least equal to the number of permanent-magnet multipolar magnetic rotors comprised in the gearshift system 500.

Furthermore, the translational movement of the modulator 110 can be suitably controlled during the transient phase of its translation between two successive permanent-magnet multipolar magnetic rotors.

The translation of the modulator 110 must occur in a given sequence that will ensure that the transmission ratio will change at the instant when the magnetic rotors reach a relative synchronization speed equal to the new transmission ratio to be obtained when such translation is complete.

The modulator 110 may thus be configured to modulate the transmission of the permanent-magnet multipolar magnetic rotors 100a and 100b simultaneously. For example, the modulator 110 may be configured for taking a third position, e.g., during a translation between the first position and the second position, wherein it is interposed between the rotors of the first permanent-magnet multipolar magnetic rotor 100a and also between the rotors of the second permanent-magnet multipolar magnetic rotor 100b; in this way, both the interaction between the rotors of the first permanent-magnet multipolar magnetic rotor and the interaction between the rotors of the second permanent-magnet multipolar magnetic rotor will be activated by the modulator 110.

For example, the modulator 110 is shown in FIG. 9 during the transition between the first permanent-magnet multipolar magnetic rotor 100a and the second permanent-magnet multipolar magnetic rotor 100b.

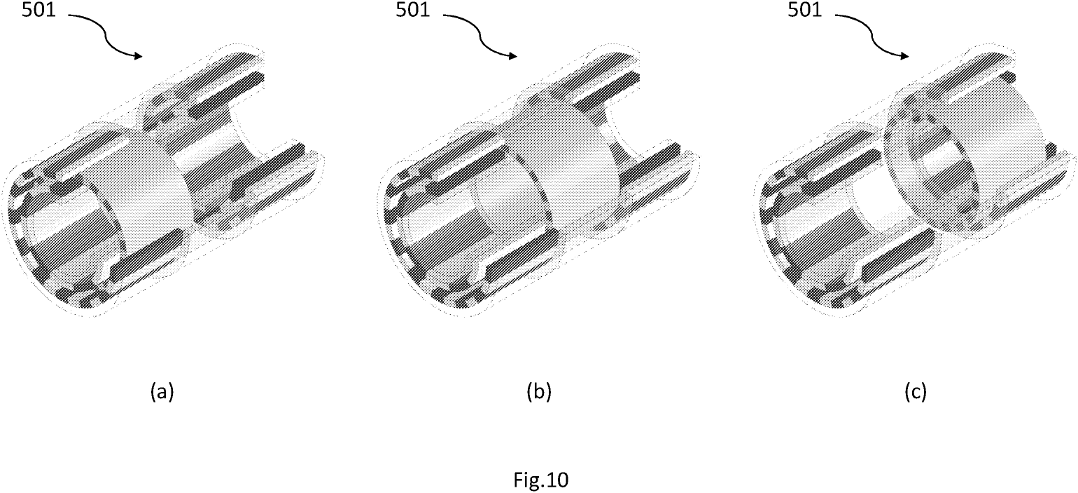

Alternatively, the modulator 110 may be configured for taking a fourth position, such as to cancel the transmission of motion in all of the permanent-magnet multipolar magnetic rotors comprised in the magnetic gearshift system 500. Said fourth position (also referred to as “neutral position” in the course of the present description) can be achieved by completely extracting the modulator from the gearshift system 500. Alternatively, the configuration of the permanent-magnet multipolar magnetic rotors 100a and 100b may be such as to cause the modulator 110 to take the neutral position, even only temporarily, while translating between the first position and the second position, and vice versa. For example, as shown in FIG. 10, the magnetic gearshift system 501 comprises a decoupling region between the permanent-magnet multipolar magnetic rotors 100a and 100b, such as to allow the modulator 110 to take a neutral position while translating between the first position and the second position. FIGS. 10a, 10b and 10c show the modulator 110a during the transition from the first position to the second position. In particular, FIG. 10a shows the modulator during the phase of disengaging from the first position; FIG. 10b shows the modulator 110 in the neutral position, wherein the modulator is not coupled with either one of the permanent-magnet multipolar magnetic rotors 100a and 100b; FIG. 10c shows the modulator during the phase of engaging into the second position.

Since the transmission of motion between the rotors of the permanent-magnet multipolar magnetic rotors 100a and 100b is achieved through the interaction between the permanent magnets of the internal and external rotors and the ferromagnetic materials comprised in the modulator 110, the rotary elements of the gearshift system 500 (i.e., the internal and external rotors and the modulator 110) have no areas in contact with each other. For this reason, as is known in the art, the gearshift system 500 can inherently be configured for interrupting the transmission of motion when a given maximum torque is exceeded. Such transmission will then be restored automatically, i.e., without requiring any control action, when the torque supplied to the rotary elements falls below the maximum transmissible torque value for which the gearshift system has been designed.

The gearshift system 500 according to the present invention can be inserted into a transmission system comprising at least one input connected to a mechanical power source and one output connected to a power-using apparatus. To this end, the internal rotors of the permanent-magnet multipolar magnetic rotors 100a and 100b may be configured to be connected to a first transmission shaft, while the external rotors of the permanent-magnet multipolar magnetic rotors 100a and 100b may be configured to be connected to a second transmission shaft. For example, the first transmission shaft may be connected to an engine to be used as an input of the transmission system. Likewise, the second transmission shaft may be connected to a power-using apparatus to be used as an output shaft of the transmission system. In this manner, the rotational motion of the first shaft will be transmitted to the second shaft via the gearshift system 500 according to a given transmission ratio. Alternatively, the first transmission shaft may be used as an output of the transmission system, while the first transmission shaft may be used as an input of the transmission system. As previously explained, the gearshift system 500 can modulate and vary the transmission ratio between the input and the output depending on the position taken by the modulator 110. As a consequence, by appropriately controlling the translation of the modulator 110 between the permanent-magnet multipolar magnetic rotors 100a and 100b, it is possible to achieve direct control over the transmission ratio between the first transmission shaft and the second transmission shaft.

For example, the gearshift system 500 may be conveniently used in a vehicle; in fact, the first transmission shaft constrained to the internal rotors may be connected to a power source and rotated at the same speed imposed by the latter. The second transmission shaft constrained to the external rotors may be connected to the differential gear and thence to the wheels of the vehicle; thus, the second transmission shaft constrained to the external rotors can be made to rotate at a speed determined by the transmission ratio as a function of the position of the modulator 110.

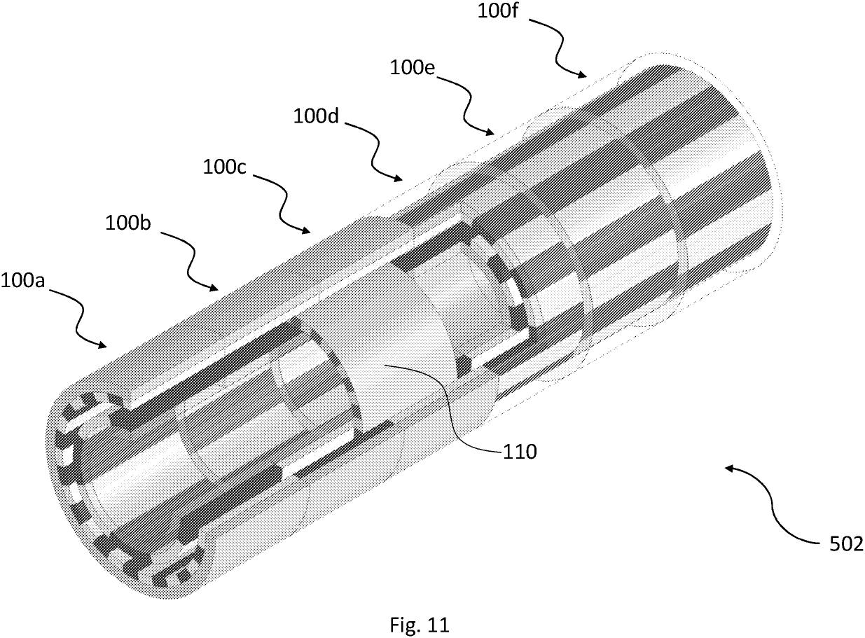

The magnetic gearshift system 500 can be configured to establish any number of transmission ratios. In FIG. 11, the magnetic gearshift system 502 according to the first embodiment allows obtaining six transmission ratios. In this respect, the magnetic gearshift system 502 shown in FIG. 11 additionally comprises other four permanent-magnet multipolar magnetic rotors 100c, 100d, 100e, 100f, which are structurally similar to the first and second permanent-magnet multipolar magnetic rotors 100a and 100b. As previously explained with reference to the magnetic gearshift system 500 shown in FIG. 10, the interaction of the rotors of each one of the permanent-magnet multipolar magnetic rotors 100a, 100b, 100c, 100d, 100e, 100f can be either modulated, i.e., activated, or cancelled depending on the position taken by the modulator 110.

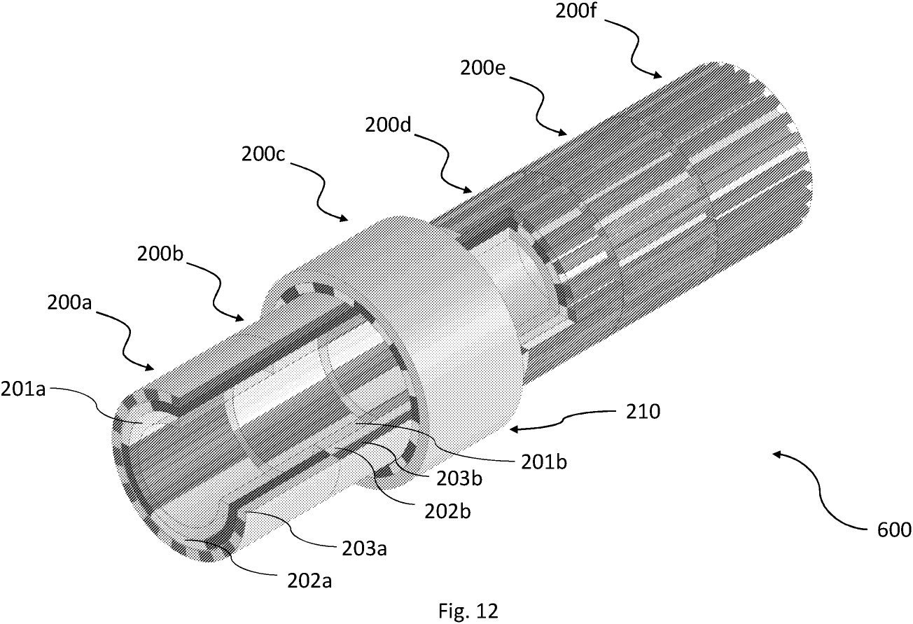

According to a second embodiment, shown in FIG. 12, the gearshift system 600 of the present invention comprises at least a first permanent-magnet multipolar magnetic rotor 200a and a second permanent-magnet multipolar magnetic rotor 200b, both of which are of the second type 200 (i.e., they are structurally similar or identical to the permanent-magnet multipolar magnetic rotor 200). Each one of the permanent-magnet multipolar magnetic rotors 200a and 200b comprises a magnetic internal rotor and a ferromagnetic intermediate rotor. For simplicity, the operation of the gearshift system 600 will be illustrated below with reference to the permanent-magnet multipolar magnetic rotors 200a and 200b alone. Of course, without departing from the scope of the present invention, the gearshift system 600 may comprise any number of permanent-magnet multipolar magnetic rotors; for example, the gearshift system 600 shown in FIG. 12 comprises six permanent-magnet multipolar magnetic rotors 200a, 200b, 200c, 200d, 200e, 200f.

As previously described, for the purpose of modulating the transmission of the permanent-magnet multipolar magnetic rotors 200a and 200b, the gearshift system 600 further comprises a magnetic modulator 210 capable of making an axial translational movement between the permanent-magnet multipolar magnetic rotors 200a and 200b. In particular, the modulator 210 is configured for taking a first position in combination with the first permanent-magnet multipolar magnetic rotor 200a and a second position in combination with the second permanent-magnet multipolar magnetic rotor 200b. As previously described, since the intermediate rotors of the permanent-magnet multipolar magnetic rotors 200a and 200b are of the ferromagnetic type, the modulator 210 must be configured to be arranged externally to the intermediate rotors. Thus, when the modulator is in the first position, the ferromagnetic intermediate rotor of the first permanent-magnet multipolar magnetic rotor 200a is interposed between the magnetic internal rotor and the magnetic modulator 210. Likewise, the ferromagnetic internal rotor of the second permanent-magnet multipolar magnetic rotor 200b is interposed between the magnetic internal rotor and the magnetic modulator 210 when the latter is in the second position.

In general, all the rotary parts of the gearshift system 600 (i.e., the internal rotors, the intermediate rotors and the modulator 210) may be left free to rotate; alternatively, at least one of the rotary parts of the gearshift system 600 may be held stationary.

For example, the intermediate rotors of the permanent-magnet multipolar magnetic rotors 200a and 200b may conveniently be held stationary, while the internal rotors, as well as the rotor 210 (i.e., the modulator 210), may be left free to rotate. Alternatively, the modulator 210 may be held stationary (i.e., the modulator 210 may be prevented from rotating), while the internal rotors, as well as the intermediate rotors, may be left free to rotate. In this manner, the transmission of the permanent-magnet multipolar magnetic rotors 200a and 200b (and, likewise, the transmission of the permanent-magnet multipolar magnetic rotors 200c, 200d, 200e, 200f) can be modulated at will by suitably translating the modulator 210 from the first position to the second position, and vice versa. For example, the transmission of motion between the rotary parts of the permanent-magnet multipolar magnetic rotors combined with the modulator 210 can be controlled, i.e., modulated, based on the position taken by the modulator 210. When the modulator 210 is positioned in the first position, it is only possible to activate the transmission of motion between the rotary parts of the permanent-magnet multipolar magnetic rotor 200a combined with the modulator 210, while cancelling the interaction between the rotary parts of the remaining permanent-magnet multipolar magnetic rotors 200b, 200c, 200d, 200e, 200f. Likewise, in the second position it is only possible to modulate the transmission of motion between the rotary parts of the permanent-magnet multipolar magnetic rotor 200b combined with the modulator 210.

The modulator 210 is common to all permanent-magnet multipolar magnetic rotors of the gearshift system 600; the number of magnetic poles Po comprised in the modulator 210 thus remains constant regardless of the position taken by the modulator 210. In order to establish predefined and distinct transmission ratios for each permanent-magnet multipolar magnetic rotor, it is therefore necessary to suitably set the number of ferromagnetic poles q comprised in the external rotors of each permanent-magnet multipolar magnetic rotor and the number of magnetic poles Pi comprised in the internal rotors of each permanent-magnet multipolar magnetic rotor. As shown in FIG. 12, the number of ferromagnetic elements of the intermediate rotors and the number of permanent magnets of the internal rotors varies depending on the transmission ratio established by the permanent-magnet multipolar magnetic rotors 200a-200f of the gearshift system 600, so as to maintain, for each stage of the gearshift system 600 (i.e., for each permanent-magnet multipolar magnetic rotor 200a-200f in combination with the modulator 210) the relationship Pi_n+Po = q_n, where n is the number of the stage taken into account.

As previously described, the gearshift system 600 can be inserted into a transmission system comprising a first transmission shaft, adapted to be connected to the internal rotors, and a second transmission shaft, adapted to be connected to the modulator 210 or to the intermediate rotors. Both transmission shafts may be alternatively used as either inputs or outputs of the transmission system.

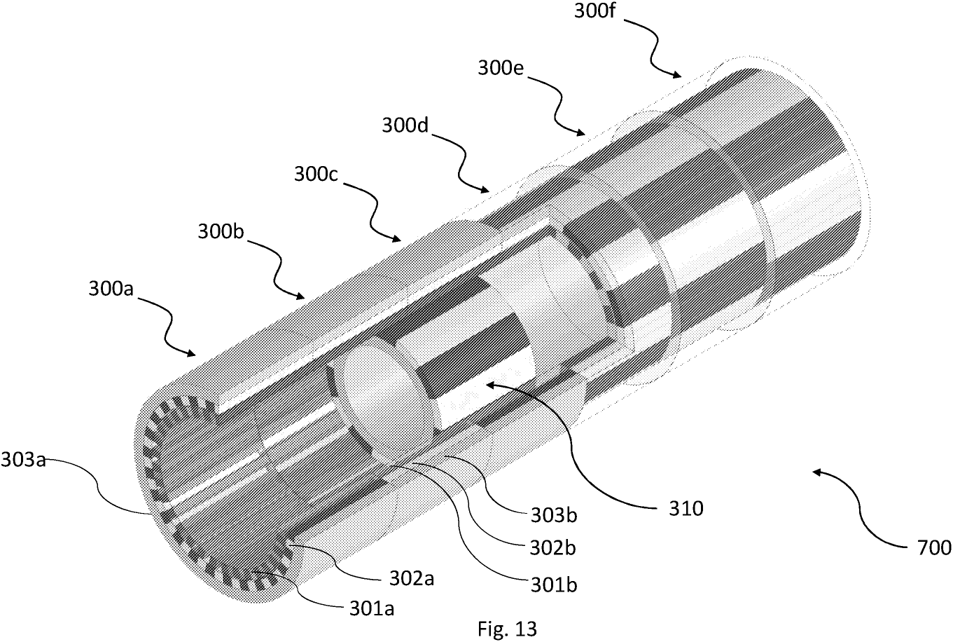

According to a third embodiment, shown in FIG. 13, the gearshift system 700 of the present invention comprises a first permanent-magnet multipolar magnetic rotor 300a and a second permanent-magnet multipolar magnetic rotor 300b of the third type 300 (i.e., they are structurally similar or identical to the permanent-magnet multipolar magnetic rotor 300). Each one of the permanent-magnet multipolar magnetic rotors 300a and 300b comprises a ferromagnetic intermediate rotor and a magnetic external rotor. For simplicity, the operation of the gearshift system 700 will be illustrated below with reference to the permanent-magnet multipolar magnetic rotors 300a and 300b alone. Of course, without departing from the scope of the present invention, the gearshift system 700 may comprise any number of permanent-magnet multipolar magnetic rotors; for example, the gearshift system 700 shown in FIG. 7 comprises six permanent-magnet multipolar magnetic rotors.

As previously described, for the purpose of modulating the transmission of the permanent-magnet multipolar magnetic rotors 300a and 300b, the gearshift system 700 further comprises a magnetic modulator 310 capable of making an axial translational movement between the permanent-magnet multipolar magnetic rotors 300a and 300b to take either a first or a second position. As previously described, since the intermediate rotors of the permanent-magnet multipolar magnetic rotors 300a and 300b are of the ferromagnetic type, the modulator 310 must be configured to be arranged internally to the intermediate rotors of the permanent-magnet multipolar magnetic rotors. Thus, the ferromagnetic intermediate rotor of the first permanent-magnet multipolar magnetic rotor 300a is interposed between the magnetic external rotor and the magnetic modulator 310 when the latter is in the first position. Likewise, the ferromagnetic intermediate rotor of the second permanent-magnet multipolar magnetic rotor 300b is interposed between the magnetic external rotor and the magnetic rotor 310 when the latter is in the second position.

In general, all the rotary parts of the gearshift system 700 (i.e., the external rotors, the intermediate rotors and the modulator 310) may be left free to rotate; alternatively, at least one of the rotary parts of the gearshift system 600 may be held stationary.

For example, the intermediate rotors of the permanent-magnet multipolar magnetic rotors 300a and 300b may conveniently be held stationary, while the external rotors, as well as the rotor 310, may be left free to rotate. Alternatively, the modulator 310 may be held stationary (i.e., the modulator 310 may be prevented from rotating), while the internal rotors and the intermediate rotors may be left free to rotate.

In this manner, the transmission of the permanent-magnet multipolar magnetic rotors 300a and 300b (and, likewise, the transmission of the permanent-magnet multipolar magnetic rotors 300c, 300d, 300e, 300f) can be modulated at will by suitably moving the modulator 110 from the first position to the second position, and vice versa. In other words, the transmission of motion between the rotary parts of the first permanent-magnet multipolar magnetic rotor 300a or between the rotary parts of the second permanent-magnet multipolar magnetic rotor 300b can be controlled, i.e., modulated, based on the position taken by the modulator 310. For example, when the modulator 310 is positioned in the first position, it is only possible to activate the transmission of motion between the rotary parts of the first permanent-magnet multipolar magnetic rotor 300a, while cancelling the interaction between the rotary parts of the remaining permanent-magnet multipolar magnetic rotors 300b, 300c, 300d, 300e, 300f. Likewise, in the second position it is only possible to modulate the transmission of motion between the rotary parts of the second permanent-magnet multipolar magnetic rotor 300a.

The modulator 310, which is common to all permanent-magnet multipolar magnetic rotors of the gearshift system 700, is of the magnetic type; the number of magnetic poles Pi comprised in the modulator 310 thus remains constant regardless of the position taken by the modulator 310. In order to establish predefined and distinct transmission ratios for each permanent-magnet multipolar magnetic rotor, it is therefore necessary, during the design phase, to appropriately select the number of ferromagnetic poles q comprised in the internal rotors of each permanent-magnet multipolar magnetic rotor and the number of magnetic poles Po comprised in the external rotors of each permanent-magnet multipolar magnetic rotor, so as to maintain, for each stage (i.e., for each permanent-magnet multipolar magnetic rotor 300a-300f in combination with the modulator 310) of the gearshift system 700, the relationship Pi+Po_n = q_n, where n is the number of the stage taken into account. As shown in FIG. 13, the number of permanent magnets of the external rotors and, consequently, the number of ferromagnetic elements of the intermediate rotors, varies depending on the transmission ratio established by the permanent-magnet multipolar magnetic rotors 300a, 300b, 300c, 300d, 300e and 300f of the gearshift system 700.

As described with reference to the preceding embodiments, the gearshift system 700 can be inserted into a transmission system comprising a first transmission shaft, adapted to be connected to the modulator 310, and a second transmission shaft, adapted to be connected to the external rotors. Both transmission shafts may be alternatively used as either inputs or outputs of the transmission system.

The magnetic gearshift systems 600 and 700, characterized by the presence of a single modulator 310 of the magnetic type, turn out to be particularly advantageous in terms of costs. In fact, the total number of permanent magnets comprised in the gearshift system is smaller than in other embodiments of the gearshift system of the present invention. As an example applying to both magnetic gearshift systems 600 and 700, the axial positioning of the modulator 210 or 310 can be obtained by means of splined-shaft solutions, or by means of fork and linkage systems similar to solution already adopted in traditional gearbox, also including synchronization systems.

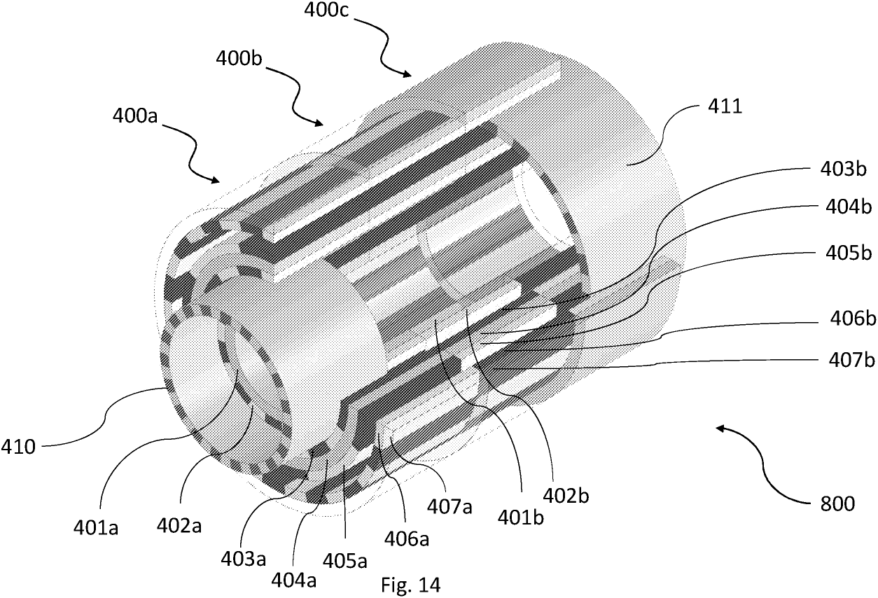

In a fourth embodiment, shown in FIG. 14, the magnetic gearshift system 800 according to the present invention comprises a first permanent-magnet multipolar magnetic rotor 400a and a second permanent-magnet multipolar magnetic rotor 400b of the fourth type 400 (i.e., structurally similar or identical to the permanent-magnet multipolar magnetic rotor 400).

As will become apparent in the following description, the magnetic gearshift system 800 is a dual-stage gearshift system. For simplicity, the operation of the gearshift system 800 depicted in FIG. 14 will be illustrated with reference to the permanent-magnet multipolar magnetic rotors 400a and 400b alone; such an embodiment can then be easily extended to any number of permanent-magnet multipolar magnetic rotors.

For the purpose of modulating the transfer of motion between the internal rotors and the intermediate rotors of the permanent-magnet multipolar magnetic rotors 400a and 400b, the gearshift system 400 comprises a first modulator 410 of the ferromagnetic type that comprises a rotor arranged coaxial to the permanent-magnet multipolar magnetic rotors 400a and 400b. Moreover, for the purpose of modulating the transfer of motion between the intermediate rotors and the external rotors of the permanent-magnet multipolar magnetic rotors 400a and 400b, the gearshift system 800 comprises a second modulator 411 of the ferromagnetic type that comprises a rotor arranged coaxial to the internal permanent-magnet multipolar magnetic rotors 400a and 400b.

In particular, the first modulator 410 is configured to make an axial translational movement between the permanent-magnet multipolar magnetic rotors 400a and 400b, so as to take at least a first position in combination with the permanent-magnet multipolar magnetic rotor 400a and a second position in combination with the permanent-magnet multipolar magnetic rotor 400b. When in the first position, the first modulator 410 is configured to interpose itself between the internal and intermediate rotors of the first permanent-magnet multipolar magnetic rotor 400a; likewise, when in the second position, the first modulator 410 is configured to interpose itself between the internal and intermediate rotors of the second permanent-magnet multipolar magnetic rotor 400b.

The second modulator 411 is configured to make an axial translational movement between the permanent-magnet multipolar magnetic rotors 400a and 400b, so as to take at least a first position in combination with the first permanent-magnet multipolar magnetic rotor 400a and a second position in combination with the second permanent-magnet multipolar magnetic rotor 400b. When in the first position, the second modulator 411 is configured to interpose itself between the intermediate and external rotors of the first permanent-magnet multipolar magnetic rotor 400a; likewise, when in the second position, the second modulator 411 is configured to interpose itself between the intermediate and external rotors of the second permanent-magnet multipolar magnetic rotor 400b. As previously described, the number of magnetic elements comprised in the permanent-magnet multipolar magnetic rotors 400a and 400b and the number of ferromagnetic elements comprised in the first modulator 410 and in the second modulator 411 can be conveniently selected to establish distinct and predefined transmission ratios for each one of the permanent-magnet multipolar magnetic rotors 400a and 400b.

Advantageously, the gearshift system 800 can be inserted into a transmission system. In particular, the internal rotors of the internal permanent-magnet multipolar magnetic rotors 400a and 400b may be configured to be connected to a first transmission shaft, while the intermediate rotors and the external rotors may be configured to be connected to a second transmission shaft and a third transmission shaft, respectively.

By way of example, the second transmission shaft, connected to the intermediate rotors, may be used as input and connected to a motor. The first and third transmission shafts may be used as outputs of the gearshift system and be connected to one or more power-using apparatuses. Otherwise, the second transmission shaft may be used as an output of the transmission system and be connected to one or more power-using apparatuses. In this latter case, the first transmission shaft and the third transmission shaft may respectively be connected to a first motor, e.g., an electric motor, and to a second motor, e.g., an internal combustion engine.

Depending on the specific application, the movements and relative positions of the modulators 410 and 411 can be suitably defined. For example, the modulators 410 and 411 may be connected to each other in such a way as to be both shifted by means of a single translational movement; alternatively, they may move independently, in this case requiring two different translational movements.

The gearshift system 800 shown in FIG. 14 is particularly advantageous whenever it is necessary to provide a large number of transmission ratios while keeping the dimensions of the gearshift system 800 small. Such a configuration turns out to be advantageous because it considerably reduces the axial dimension of the magnetic gearshift system 800.

Furthermore, when the intermediate rotor is connected to the motor and the internal and external rotors are used as a power output, such external rotors may be configured to establish transmission ratios generating low output speeds, resulting in the availability of a higher output torque due to the larger size of the external rotors, thus having the gearbox operate as a speed reducer. Likewise, the internal rotors of the gears 400a and 400b may be configured to ensure a higher output speed and a lower torque compared with the power input, thus having the gearbox operate as a speed multiplier.

As an alternative to the above-described embodiments, the magnetic gearshift system according to the present invention may likewise be implemented on the basis of magnetic systems like, for example, a magnetic system comprising a magnetic wheel and a magnetic worm screw in combination with a ferromagnetic modulator; alternatively, the magnetic gearshift system according to the present invention may comprise degenerate kinematic systems similar to a pinion-rack mechanism, consisting of a magnetic wheel and a straight component composed of magnets having alternate polarity. Other possible solutions include conical magnetic wheels, magnetic harmonic gears, axial and linear magnetic wheels, as described in Tlali P.M. et al., “Magnetic gear technologies: a review”, IEEE, 2014, pp. 544-550.

The gearshift system of the present invention offers, in all of its embodiments, the advantage that it can do without additional elements such as, for example, a clutch. In fact, during gear change transitions, by adequately controlling the speed of the power source (i.e., the speed of the transmission shaft used as input), it is possible to control the translation of the modulator without having to interrupt the transmission of the motion of the permanent-magnet multipolar magnetic rotors comprised in the gearshift system. In fact, unlike mechanical gearshift systems, in this case the translational movement of the modulator is not hindered by the presence of constraints caused by mechanical contact between the rotary elements.

In addition, due to the magnetic nature of the gears comprised in the gearshift system of the present invention (i.e., due to the absence of contact between the various parts of the permanent-magnet multipolar magnetic rotor), it is possible to limit the maximum torque that can be transferred between the gears of the gearshift system without having to use other mechanical components that would be particularly subject to wear. Moreover, the gearshift system of the present invention eliminates the engagement noise that is typical of traditional mechanical gearboxes, allowing the transfer of torque between the input and the output with no contact between mechanical components. Furthermore, the absence of contact between mechanical components results in the same not being subject to wear, leading to better durability.

It can therefore be easily understood that the present invention is not limited to the above-described embodiments of the magnetic gearshift system, but may be subject to many modifications, improvements or replacements of equivalent parts and elements without departing from the inventive idea, as clearly specified in the following claims.

1. A magnetic gearshift system comprising:
a first permanent-magnet multipolar magnetic rotor;
a second permanent-magnet multipolar magnetic rotor;
a first magnetic or ferromagnetic modulator;
wherein said first modulator is configured for taking:
a first position, corresponding with the first permanent-magnet multipolar magnetic rotor, wherein said first modulator is adapted to modulate the transmission of the first permanent-magnet multipolar magnetic rotor; and
a second position, corresponding with the second permanent-magnet multipolar magnetic rotor, wherein said first modulator is adapted to modulate the transmission of the second permanent-magnet multipolar magnetic rotor.

2. The magnetic gearshift system according to claim 1, wherein:
said first modulator is such as to modulate the transmission of the first permanent-magnet multipolar magnetic rotor based on a first predefined transmission ratio;
said first modulator is such as to modulate the transmission of the second permanent-magnet multipolar magnetic rotor based on a second predefined transmission ratio.

3. The magnetic gearshift system according to claim 1, wherein:
said first modulator is configured for taking at least a third position, so as to modulate the transmission of the first permanent-magnet multipolar magnetic rotor and the transmission of the second permanent-magnet multipolar magnetic rotor at the same time.

4. The magnetic gearshift system according to claim 1, wherein:
said first modulator is configured for taking at least one neutral position.

5. The magnetic gearshift system according to claim 1, wherein:
said first permanent-magnet multipolar magnetic rotor comprises an internal first rotor and an external second rotor, said internal first rotor comprising a first yoke and a first plurality of permanent magnets, said external second rotor comprising a second yoke and a second plurality of permanent magnets;
said second permanent-magnet multipolar magnetic rotor comprises an internal third rotor and an external fourth rotor, said internal third rotor comprising a third yoke and a third plurality of permanent magnets, said external fourth rotor comprising a fourth yoke and a fourth plurality of permanent magnets;
said first modulator comprises a supporting structure made of resin or another non-ferromagnetic material, with ferromagnetic inserts arranged angularly equidistant, and is configured for interposing itself:
between the internal first rotor and the external second rotor when in the first position, so as to modulate the transmission between the internal first rotor and the external second rotor;
between the internal third rotor and the external fourth rotor when in the second position, so as to modulate the transmission between the internal third rotor and the external fourth rotor.

6. The magnetic gearshift system according to claim 5, wherein:
the internal first rotor and the internal third rotor are adapted to be connected to a first transmission shaft;
the external second rotor and the external fourth rotor are adapted to be connected to a second transmission shaft.

7. The magnetic gearshift system according to claim 1, wherein:
said first permanent-magnet multipolar magnetic rotor comprises an internal first rotor and an intermediate second rotor, said internal first rotor comprising a first yoke and a first plurality of permanent magnets, said intermediate second rotor comprising a first plurality of ferromagnetic elements;
said second permanent-magnet multipolar magnetic rotor comprises an internal third rotor and an intermediate fourth rotor, said internal third rotor comprising a second yoke and a second plurality of permanent magnets, said intermediate fourth rotor comprising a second plurality of ferromagnetic elements;
said first modulator is of the magnetic type and comprises a third yoke and a third plurality of permanent magnets, said first modulator being configured for:
arranging itself externally to the intermediate second rotor when in the first position;
arranging itself externally to the intermediate fourth rotor when in the second position.

8. The magnetic gearshift system according to claim 7, wherein:
said internal first rotor and said internal third rotor are configured to be connected to a first transmission shaft;
said first modulator is configured to be connected to a second transmission shaft, or said intermediate second rotor and said intermediate fourth rotor are configured to be connected to said second transmission shaft.

9. The magnetic gearshift system according to claim 1, wherein:
said first permanent-magnet multipolar magnetic rotor comprises an intermediate first rotor and an external second rotor, said intermediate first rotor comprising a first plurality of ferromagnetic elements, said external second rotor comprising a first yoke and a first plurality of permanent magnets;
said second permanent-magnet multipolar magnetic rotor comprises an intermediate third rotor and an external fourth rotor, said intermediate third rotor comprising a second plurality of ferromagnetic elements, said external fourth rotor comprising a second yoke and a second plurality of permanent magnets;
said first modulator is of the magnetic type and comprises a third yoke and a third plurality of permanent magnets, said first modulator being configured for:
arranging itself internally to the intermediate second rotor when in the first position;
arranging itself internally to the intermediate fourth rotor when in the second position.

10. The magnetic gearshift system according to claim 9, wherein:
said first modulator is adapted to be connected to a first transmission shaft, or said intermediate first rotor and said intermediate third rotor are adapted to be connected to a first transmission shaft;
said external second rotor and said external fourth rotor are adapted to be connected to a second transmission shaft.

11. The magnetic gearshift system according to claim 6, wherein:
said first transmission shaft is adapted to be connected to a first motor and said second transmission shaft is adapted to be used as an output shaft, or
said first transmission shaft is adapted to be used as an output shaft and said second transmission shaft is adapted to be connected to a first motor.

12. The magnetic gearshift system according to claim 1, wherein:
said first permanent-magnet multipolar magnetic rotor comprises an internal first rotor, an intermediate second rotor and an external third rotor,
said internal first rotor comprising a first yoke and a first plurality of permanent magnets,
said intermediate second rotor comprising a second yoke, a second plurality of permanent magnets and a third plurality of permanent magnets;
said external third rotor comprising a third yoke and a fourth plurality of permanent magnets;
said second permanent-magnet multipolar magnetic rotor comprises an internal fourth rotor, an intermediate fifth rotor and an external sixth rotor,
said internal fourth rotor comprising a fourth yoke and a fifth plurality of permanent magnets,
said intermediate fifth rotor comprising a fifth yoke, a sixth plurality of permanent magnets and a seventh plurality of permanent magnets;
said external sixth rotor comprising a sixth yoke and an eighth plurality of permanent magnets;
said first modulator is of the ferromagnetic type and is configured for interposing itself:
between the internal first rotor and the intermediate second rotor when in the first position, so as to modulate the transmission ratio between the internal first rotor and the intermediate second rotor;
between the internal fourth rotor and the intermediate fifth rotor when in the second position, so as to modulate the transmission ratio between the internal fourth rotor and the intermediate fifth rotor;
said magnetic gearshift system further comprising:
a second modulator of the ferromagnetic type configured for interposing itself:
between the intermediate second rotor and the external third rotor when in a fourth position, so as to modulate the transmission ratio between the intermediate second rotor and the external third rotor;
between the intermediate fifth rotor and the external sixth rotor when in a fifth position, so as to modulate the transmission ratio between the intermediate fifth rotor and the external sixth rotor.

13. The magnetic gearshift system according to claim 12, wherein:
the internal first rotor and the internal fourth rotor are adapted to be connected to a first transmission shaft;
the intermediate second rotor and the intermediate fifth rotor are adapted to be connected to a second transmission shaft;
the external third rotor and the external sixth rotor are adapted to be connected to a third transmission shaft.

14. The magnetic gearshift system according to claim 13, wherein:
said first transmission shaft is adapted to be used as an output shaft;
said second transmission shaft is adapted to be connected to a first motor;
said third transmission shaft is adapted to be connected to a second motor.

15. The magnetic gearshift system according to claim 13, wherein:
said first transmission shaft is adapted to be connected to a first motor;
said second transmission shaft is adapted to be used as a first output shaft;
said third transmission shaft is adapted to be used as a second output shaft.
